(19) United States
(12) Patent Application Publication
(10) Pub. No.: US 2022/0053733 A1
(43) Pub. Date: Feb. 24, 2022

(54) Healing Pet Garment Apparatus

(71) Applicant: Julie Oakes, Ottawa, IL (US)

(72) Inventor: Julie Oakes, Ottawa, IL (US)

(21) Appl. No.: 16/996,420

(22) Filed: Aug. 18, 2020

(51) Int. Cl. A01K 13/00; A61D 9/00

(52) U.S. Cl. CPC A01K 13/006; A61D 9/00

(57) ABSTRACT

A healing pet garment apparatus for allowing a pet to heal safely and comfortably includes a garment body. A top side has a main opening defining a top left portion and a top right portion adjacent a left side and a right side, respectively. A first fastener is coupled to the top left portion on the inner side. A second fastener is coupled to the top right portion on the outer side. The first fastener and the second fastener are selectively engageable to secure the top left portion and the top right portion in a closed position to define a neck aperture. A pair of front legs is integrally coupled to, and extending from, an underside proximal a head side. A pair of rear legs is integrally coupled to, and extending from, the underside proximal a tail side.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to pet healing devices and more particularly pertains to a new pet healing device for allowing a pet to heal safely and comfortably.

### (2) Description of Related Art Including Information Disclosed Under 37 CFR 1.97 and 1.98

The prior art relates to pet healing devices. Existing devices are often garments with a plurality of attachment mechanisms and lack a large tab to easily open and remove the device. Existing devices also fail to provide delivery of silver ions for anti-microbial purposes and improved healing.

### BRIEF SUMMARY OF THE INVENTION

An embodiment of the disclosure meets the needs presented above by generally comprising a garment body having an underside, a top side, a left side, a right side, a head side, a tail side, an inner side, and an outer side. The top side has a main opening defining a top left portion and a top right portion adjacent the left side and the right side, respectively. A first fastener is coupled to the garment body. The first fastener is coupled to the top left portion on the inner side. A second fastener is coupled to the garment body. The second fastener is coupled to the top right portion on the outer side. The first fastener and the second fastener are selectively engageable to secure the top left portion and the top right portion in a closed position to define a neck aperture. A pair of front legs is coupled to the garment body and is integrally coupled to, and extending from, the underside proximal the head side. A pair of rear legs is coupled to the garment body and is integrally coupled to, and extending from, the underside proximal the tail side.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a healing pet garment apparatus according to an embodiment of the disclosure.

FIG. 2 is a front elevation view of an embodiment of the disclosure.

FIG. 3 is a rear elevation view of an embodiment of the disclosure.

FIG. 4 is a bottom plan view of an embodiment of the disclosure.

FIG. 5 is a side elevation view of an embodiment of the disclosure.

### DETAILED DESCRIPTION OF THE INVENTION

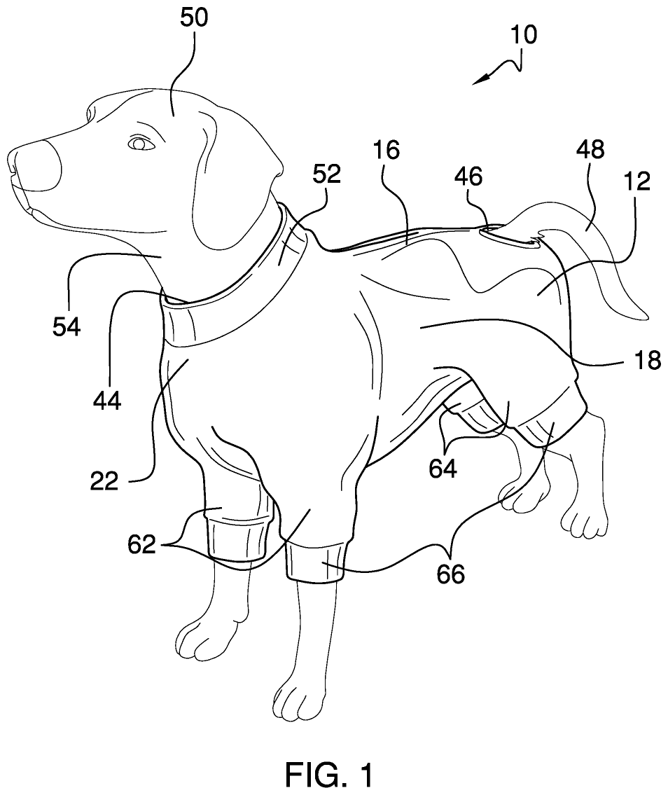

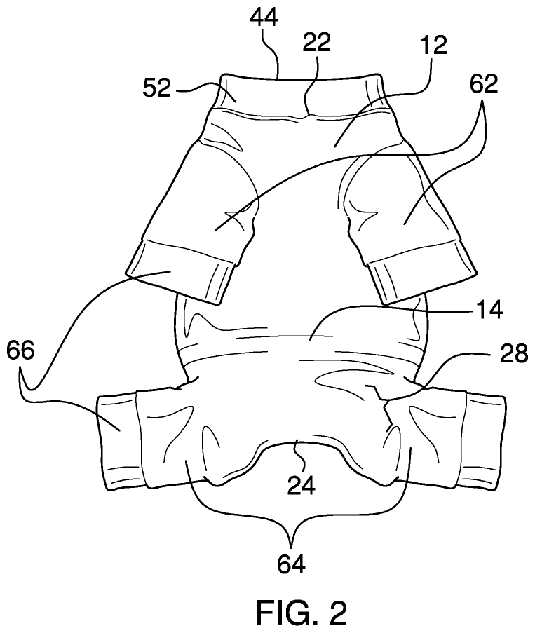

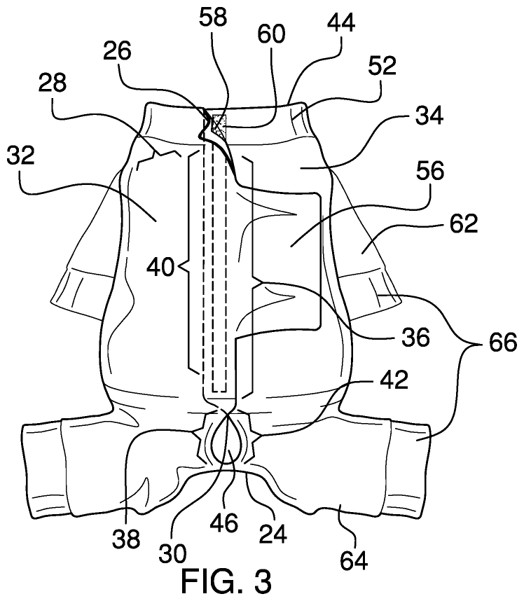

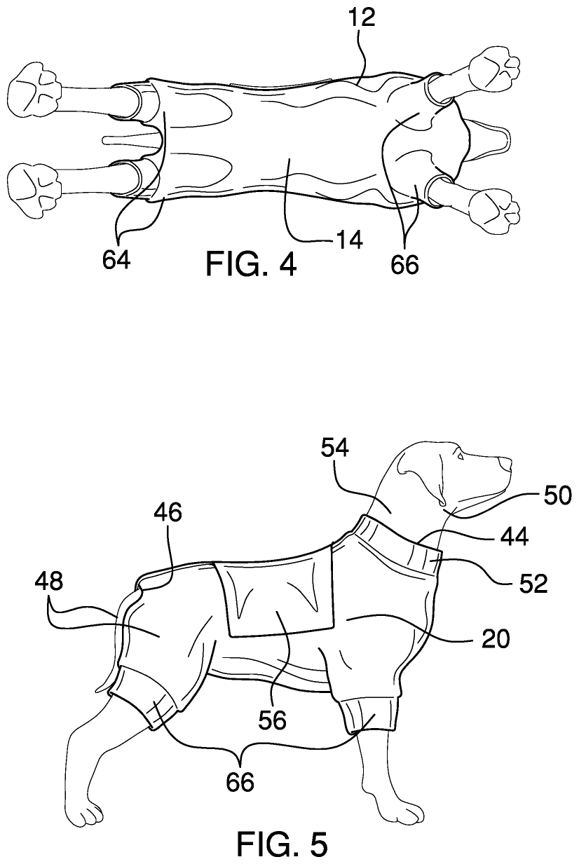

With reference now to the drawings, and in particular to FIGS. 1 through 5 thereof, a new pet healing device embodying the principles and concepts of an embodiment of the disclosure and generally designated by the reference numeral 10 will be described.

As best illustrated in FIGS. 1 through 5, the healing pet garment apparatus 10 generally comprises a garment body 12 having an underside 14, a top side 16, a left side 18, a right side 20, a head side 22, a tail side 24, an inner side 26, and an outer side 28. The top side 16 has a main opening 30 defining a top left portion 32 and a top right portion 34 adjacent the left side 18 and the right side 20, respectively.

The top left portion 32 may have a left straight section 36 and a left rounded bottom section 38 and the top right portion 34 may have a right straight section 40 and a right rounded bottom section 42. The top left portion 32 and the top right portion 34 in a closed position close the main opening 30 except for a neck aperture 44 adjacent the head side 22 and a tail aperture 46 adjacent the tail side 24. The left rounded bottom section 38 and the right rounded bottom section 42 form the tail aperture 46 configured to receive a tail 48 of a quadruped 50. The garment body 12 may have an elasticized collar portion 52 adjacent the neck aperture 44 to more comfortably receive a neck 54 of the quadruped.

A flap 56 may be coupled to the garment body 12. The flap 56 is coupled to the top left portion 32 and extends onto the right side 20 when in the closed position. A first fastener 58 is coupled to the top left portion 32 on the inner side 26 adjacent the left straight section 36. A second fastener 60 is coupled to the top right portion 34 on the outer side 28 adjacent the right straight section 40. The first fastener 58 and the second fastener 60 are selectively engageable to secure the top left portion 32 and the top right portion 34 in the closed position. The first fastener 58 and the second fastener 60 may be, but are not limited to, hook and loop fasteners, snaps, buttons, and the like. The flap 56 allows for easy separation of the top left portion 32 and the top right portion 34.

A pair of front legs 62 is coupled to the garment body 12. The pair of front legs is integrally coupled to, and extending from, the underside 14 proximal the head side 22. A pair of rear legs 64 is coupled to the garment body 12. The pair of rear legs 64 is integrally coupled to, and extending from, the underside 14 proximal the tail side 24. Each of the pair of front legs 62 and the pair of rear legs 64 may have an elasticized cuff portion 66.

Each of the garment body 12, the pair of front legs 62, and the pair of rear legs 64 may be a moisture-wicking material infused with colloidal silver for comfort and healing of the quadruped 50. The colloidal silver has anti-microbial properties to aid in healing.

In use, the legs of the quadruped are placed within the pair of front legs 62 and the pair of rear legs 64. The main opening 30 is moved and secured in the closed position with the first fastener 58 and the second fastener 60 to secure the apparatus 10 on the quadruped 50 for protection and healing of a surgery or wound, or for pet comfort or costuming.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A healing pet garment apparatus comprising:
a garment body having an underside, a top side, a left side, a right side, a head side, a tail side, an inner side, and an outer side, the top side having a main opening defining a top left portion and a top right portion adjacent the left side and the right side, respectively;
a first fastener coupled to the garment body, the first fastener being coupled to the top left portion on the inner side;
a second fastener coupled to the garment body, the second fastener being coupled to the top right portion on the outer side, the first fastener and the second fastener being selectively engageable to secure the top left portion and the top right portion in a closed position to define a neck aperture;
a pair of front legs coupled to the garment body, the pair of front legs being integrally coupled to, and extending from, the underside proximal the head side; and
a pair of rear legs coupled to the garment body, the pair of rear legs being integrally coupled to, and extending from, the underside proximal the tail side.

2. The healing pet garment apparatus of claim 1 further comprising each of the garment body, the pair of front legs, and the pair of rear legs being infused with colloidal silver.

3. The healing pet garment apparatus of claim 1 further comprising each of the garment body, the pair of front legs, and the pair of rear legs being a moisture-wicking material.

4. The healing pet garment apparatus of claim 1 further comprising a flap coupled to the garment body, the flap being coupled to the top left portion and extending onto the right side when in the closed position.

5. The healing pet garment apparatus of claim 1 further comprising the top left portion and the top right portion in the closed position closing the main opening except for the neck aperture and a tail aperture adjacent the tail side.

6. The healing pet garment apparatus of claim 5 further comprising the top left portion having a left straight section and a left rounded bottom section, the top right portion having a right straight section and a right rounded bottom section, the first fastener and the second fastener being coupled adjacent the left straight section and the right straight section, respectively, the left rounded bottom section and the right rounded bottom section forming the tail aperture in the closed position.

7. The healing pet garment apparatus of claim 1 further comprising the garment body having an elasticized collar portion adjacent the neck aperture; each of the pair of front legs and the pair of rear legs having an elasticized cuff portion.

8. A healing pet garment apparatus comprising:
a garment body having an underside, a top side, a left side, a right side, a head side, a tail side, an inner side, and an outer side, the top side having a main opening defining a top left portion and a top right portion adjacent the left side and the right side, respectively, the top left portion having a left straight section and a left rounded bottom section, the top right portion having a right straight section and a right rounded bottom section, the top left portion and the top right portion in a closed position closing the main opening except for a neck aperture adjacent the head side and a tail aperture adjacent the tail side, the left rounded bottom section and the right rounded bottom section forming the tail aperture, the garment body having an elasticized collar portion adjacent the neck aperture;
a flap coupled to the garment body, the flap being coupled to the top left portion and extending onto the right side when in the closed position;
a first fastener coupled to the garment body, the first fastener being coupled to the top left portion on the inner side adjacent the left straight section;
a second fastener coupled to the garment body, the second fastener being coupled to the top right portion on the outer side coupled adjacent the right straight section, the first fastener and the second fastener being selectively engageable to secure the top left portion and the top right portion in the closed position;
a pair of front legs coupled to the garment body, the pair of front legs being integrally coupled to, and extending from, the underside proximal the head side; and
a pair of rear legs coupled to the garment body, the pair of rear legs being integrally coupled to, and extending from, the underside proximal the tail side, each of the pair of front legs and the pair of rear legs having an elasticized cuff portion;
wherein each of the garment body, the pair of front legs, and the pair of rear legs is a moisture-wicking material infused with colloidal silver.
